(19) United States
(12) Patent Application Publication
(10) Pub. No.: US 2015/0244773 A1
(43) Pub. Date: Aug. 27, 2015

(54) DIAGNOSIS AND OPTIMIZATION OF CLOUD RELEASE PIPELINES

(71) Applicant: GOOGLE INC., Mountain View, CA (US)

(72) Inventors: Rae WANG, Mountain View, CA (US); Kenneth Paul FISHKIN, Mountain View, CA (US); Chris SMITH, Mountain View, CA (US)

(73) Assignee: GOOGLE INC., Mountain View, CA (US)

(21) Appl. No.: 14/191,168

(22) Filed: Feb. 26, 2014

(51) Int. Cl. H04L 29/08

(52) U.S. Cl. CPC H04L 67/10

(57) ABSTRACT

Provided are methods and systems for providing users with a tool that can offer recommendations on how to optimize the development and performance of their applications. A diagnosis and optimization method, system, and engine captures various data associated with, for example, building, deploying, releasing, and running a user's application, and utilizes such data to generate recommendations/suggestions as to how the user can best balance high release productivity, ease of management, and cost optimization. The methods and systems utilize the end-to-end story of a user's development process (e.g., from the time the user submits code to when the application is actually up and running) to generate recommendations as to ways that the user can optimize their system including, for example, how the user can layout their application topology differently, reduce latency, increase data locality, or optimize billing costs.

### BACKGROUND

Cloud gives users new capabilities for scaling their workloads. Release workflows benefit greatly from it. For example, testing of different scenarios can now be done in parallel as there are no longer the limitations imposed by hardware resources.

However, this scaling can come at a high cost if not managed properly. Cloud customers have become very conscious of costs. They want to be able to balance high release productivity, ease of management and cost optimization. There are many factors that can contribute to the optimization of a cloud release pipeline including, for example, pipeline topology, release schedule, scaling rules, automation level, chosen resources, pricing options, and payment methods. Keeping track of all of these factors and tuning them for optimal setup is difficult to do manually.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

The present disclosure generally relates to methods and systems for providing online services to users. More specifically, aspects of the present disclosure relate to providing users with the ability to receive recommendations on optimizing the development and performance of their applications.

One embodiment of the present disclosure relates to a computer-implemented method comprising: obtaining release workflow data associated with an application; obtaining production workload data associated with the application; storing the release workflow data and the production workload data in a database; combining the release workflow data and the production workload data obtained for the application with data associated with one or more other applications; analyzing the combined data to generate diagnosis and optimization recommendations; and providing the generated recommendations to the user.

In another embodiment, obtaining release workflow data associated with the application includes capturing data associated with the execution of one or more stages of a pipeline defined for the application.

In yet another embodiment, obtaining production workload data associated with the application includes: determining that the application has been deployed; monitoring the deployed application; and generating data based on the monitoring of the deployed application.

In another embodiment, monitoring the deployed application includes determining an amount of resources being utilized by the deployed application.

In still another embodiment, monitoring the deployed application includes determining an allocation of utilized resources across the deployed application.

In another embodiment, providing the generated recommendations to the user includes providing the recommendations for display in a user interface screen accessible by the user.

Another embodiment of the present disclosure relates to a system comprising one or more processors and a non-transitory computer-readable medium coupled to the one or more processors having instructions stored thereon that, when executed by the one or more processors, cause the one or more processors to perform operations comprising: obtaining release workflow data associated with an application; obtaining production workload data associated with the application; storing the release workflow data and the production workload data in a database; combining the release workflow data and the production workload data obtained for the application with data associated with one or more other applications; analyzing the combined data to generate diagnosis and optimization recommendations; and providing the generated recommendations to the user.

In another embodiment, the one or more processors of the system are caused to perform further operations comprising capturing data associated with the execution of one or more stages of a pipeline defined for the application.

In yet another embodiment, the one or more processors of the system are caused to perform further operations comprising: determining that the application has been deployed; monitoring the deployed application; and generating data based on the monitoring of the deployed application.

In still another embodiment, the one or more processors of the system are caused to perform further operations comprising determining an amount of resources being utilized by the deployed application.

In still another embodiment, the one or more processors of the system are caused to perform further operations comprising obtaining pricing data associated with the one or more other applications from one or more sources separate from the application.

In another embodiment, the one or more processors of the system are caused to perform further operations comprising: generating a user interface screen accessible by the user; and providing the recommendations for display in the user interface screen.

Yet another embodiment of the present disclosure relates to one or more non-transitory computer readable media storing computer-executable instructions that, when executed by one or more processors, causes the one or more processors to perform operations comprising: obtaining release workflow data associated with an application; obtaining production workload data associated with the application; storing the release workflow data and the production workload data in a database; combining the release workflow data and the production workload data obtained for the application with data associated with one or more other applications; analyzing the combined data to generate diagnosis and optimization recommendations; and providing the generated recommendations to the user.

In one or more other embodiments, the methods, systems, and computer readable media described herein may optionally include one or more of the following additional features: the data associated with one or more other applications includes pricing data associated with one or more other applications; the release workflow data associated with the application includes at least one of data associated with building the application, data associated with deploying the application, and data associated with releasing the application; and/or the pricing data associated with the one or more other applications is obtained from one or more sources separate from the application.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the disclosure will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example cloud computing environment according to one or more embodiments described herein.

FIG. 2 is a schematic diagram illustrating an example system for diagnosis and optimization of cloud release pipelines including example data flows between components of the system according to one or more embodiments described herein.

FIG. 3 is a flowchart illustrating an example method for providing diagnostic and optimization recommendations to a user based on data associated with the development and performance of the user's application according to one or more embodiments described herein.

FIG. 4 is a user interface illustrating an example cloud management console according to one or more embodiments described herein.

FIG. 5 is a graphical user interface screen illustrating another example of a cloud management console according to one or more embodiments described herein.

FIG. 6 is a graphical user interface screen illustrating another example of a cloud management console according to one or more embodiments described herein.

FIG. 7 is a block diagram illustrating an example computing device arranged for providing users with the ability to receive recommendations on how to optimize the development and performance of their applications according to one or more embodiments described herein.

The headings provided herein are for convenience only and do not necessarily affect the scope or meaning of what is claimed in the present disclosure.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples and embodiments will now be described. The following description provides specific details for a thorough understanding and enabling description of these examples. One skilled in the relevant art will understand, however, that one or more embodiments described herein may be practiced without many of these details. Likewise, one skilled in the relevant art will also understand that one or more embodiments of the present disclosure can include many other obvious features not described in detail herein. Additionally, some well-known structures or functions may not be shown or described in detail below, so as to avoid unnecessarily obscuring the relevant description.

With the advent of cloud computing, there exists an opportunity to conduct more of the application development process online. For example, having knowledge about a developer's application source code, build, how the application is being deployed, where the application is being deployed, when the application is running under a heavy/light load, etc., allows for the collection of relevant data about the development process of the application. Such collected data may be used to provide the developer with recommendations on how to optimize deployment, source code configurations, and the like.

Embodiments of the present disclosure relate to methods and systems for providing users with a tool that can offer recommendations on optimizing the development and performance of their applications. For example, in accordance with one or more embodiments described herein, a diagnosis and optimization engine may capture various data associated with, for example, building, deploying, releasing, and running an application, and may utilize such data to generate recommendations/suggestions as to how a user (e.g., developer of the application) can best balance high release productivity, ease of management, and cost optimization.

As will be described in greater detail below, the methods and systems of the present disclosure provide users (e.g., customers, subscribers, developers, etc.) with the ability to receive diagnosis and optimization suggestions based on data collected during various stages of the deployment pipeline for their applications. As users' applications and priorities change over time, they also need to re-tune the optimization and play what-if scenarios to understand trade-offs. For example, many cloud providers offer reservations that assume usage is constant over time. However, that is not how most workloads operate in reality. Accordingly, one or more embodiments described herein utilize knowledge of customers' development workflow to offer reservation packages for non-constant usage patterns.

The methods and systems of the present disclosure utilize the end-to-end story of a user's development process (e.g., from the time the user submits code to when the application is actually up and running) to generate recommendations as to ways that the user can optimize their system. For example, recommendations may be made as to how a user can layout their application topology differently, reduce latency, increase data locality, or even optimize billing costs. For example, the optimization engine described herein may determine that various cloud resources are more expensive during the time periods that the user typically utilizes such resources than during other time periods. As such, the optimization engine may recommend that the user adjust existing workloads in order to take advantage of lower prices (e.g., in a different part of the country).

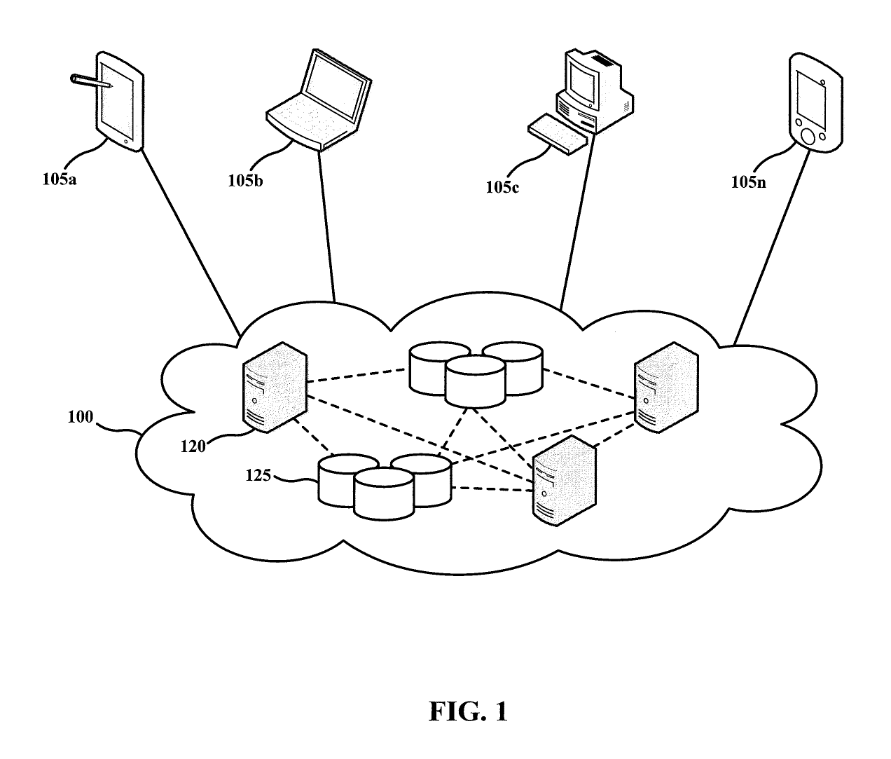

FIG. 1 is an example cloud computing environment 100 in which one or more embodiments of the present disclosure may be implemented. Cloud computing environment 100 may include one or more network or cloud computing nodes 120, 125 with which end nodes 105a, 105b, 105c, 105n (where “n” is an arbitrary number) may communicate. End nodes 105a, 105b, 105c, 105n (e.g., local computing devices, user devices, etc.) may include, for example, portable computing devices such as tablet computers (105a), laptop computers (105b), etc., desktop computers (105c), personal digital assistants (PDA) (105n), cellular telephones, smartphones, and the like. It should be understood that the particular end nodes (105a, 105b, 105c, 105n) illustrated in FIG. 1 are only some examples of the types of devices that may communicate with the cloud computing nodes 120, 125, and that numerous other types of end nodes may also communicate with the cloud computing environment 100 over a variety of different networks and/or network addressable connections (e.g., web browser).

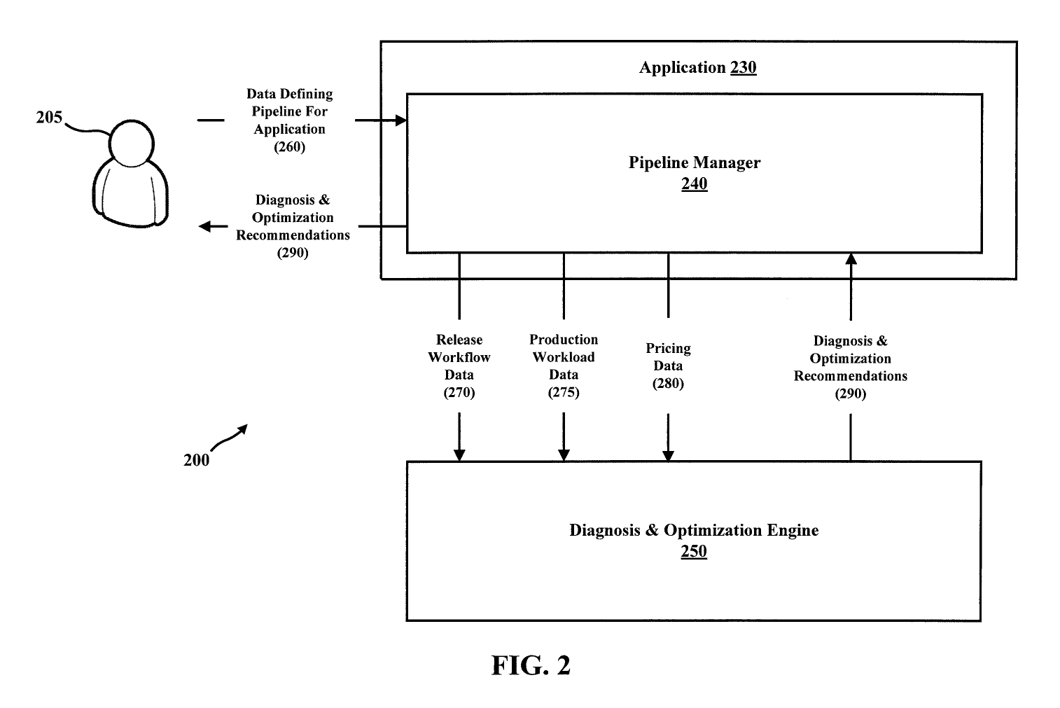

FIG. 2 is an example system 200 for providing diagnosis and optimization recommendations for cloud release pipelines. In accordance with one or more embodiments described herein, the system 200 may include diagnosis and optimization engine 250, pipeline manager 240, and application 230 (e.g., a web application).

As will be described in greater detail below, a user may define a “pipeline” for an application. For example, the user 205 may define a pipeline for the application 230 by providing pipeline manager 240 with various data (e.g., data defining pipeline for application (260)) about the application 230. In accordance with one or more embodiments described herein, the data that may be provided by the user to define the pipeline may include, for example, data specifying how the application 230 is to be built, how and where the application 230 is to be deployed, how often the application 230 should be released, the conditions under which to revert to a previous release of the application 230, and the like.

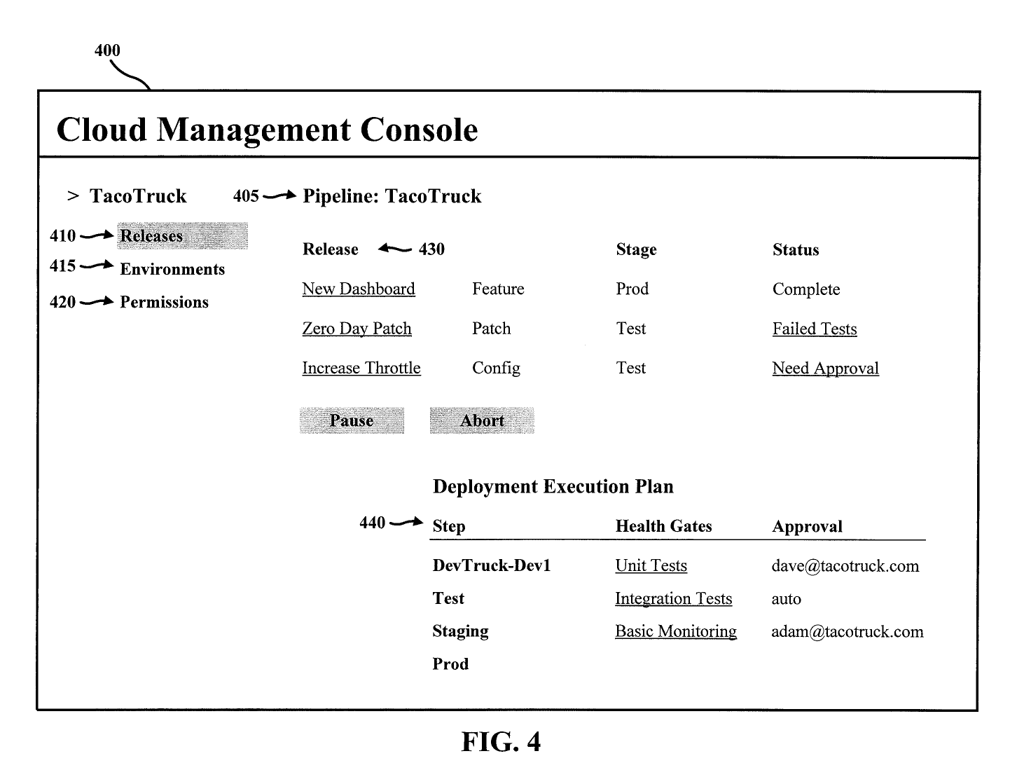

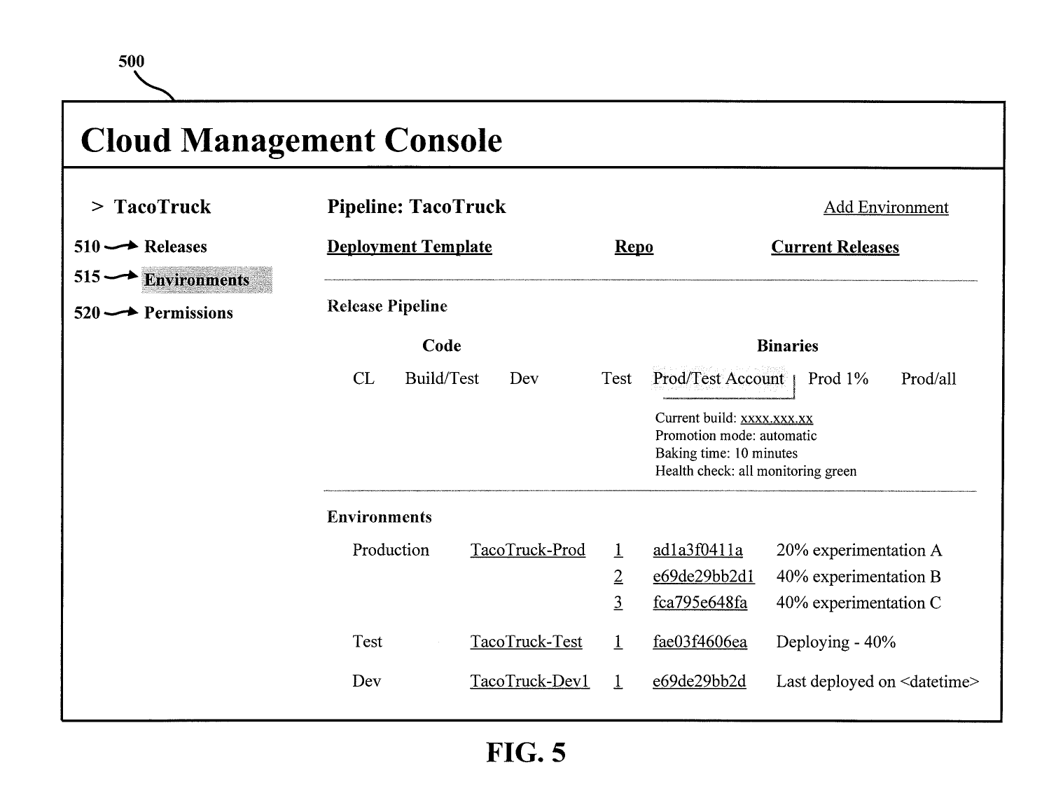

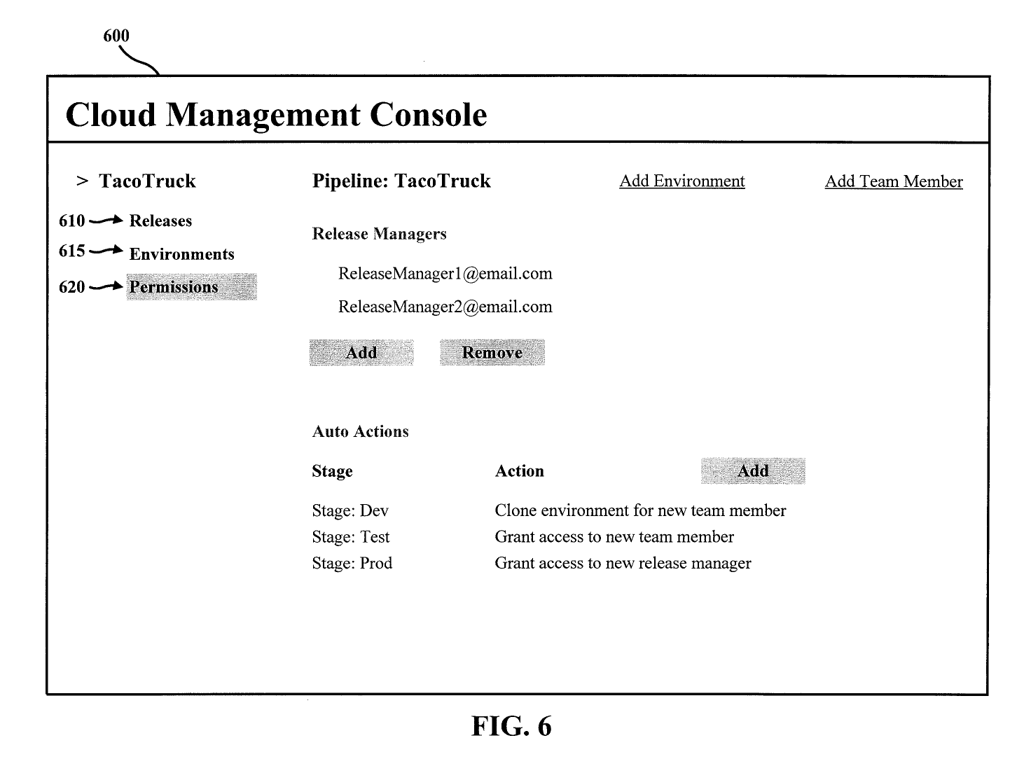

In accordance with one or more embodiments of the present disclosure, the user 205 may provide the data defining the pipeline for the application (260) via a web-based user interface editor (e.g., Cloud Management Console user interfaces 400, 500, and 600 illustrated in FIGS. 4-6 and described in further detail below). For example, the user interface editor may be associated with the pipeline manager 240, and may include one or more consoles configured to enable the user to enter and submit various data associated with the development, testing, production, and deployment of the application.

FIGS. 4-6 illustrate example user interfaces that may be used in implementing one or more of the methods and systems described herein. For example, a user may be provided with a Cloud Management Console (illustrated in user interface screens 400, 500, and 600 of FIGS. 4, 5, and 6, respectively) to allow the user to setup, submit, and manage a pipeline for their application. In accordance with one or more embodiments of the present disclosure, users are provided with the ability to monitor, compare and optimize all of their cloud deployments and assets from a single dashboard.

Various features and components of the illustrative user interfaces presented in FIGS. 4-6 are described in the context of an example scenario involving an Application “TacoTruck”, where Application “TacoTruck” includes a defined pipeline (e.g., Pipeline 405 in the example user interface screen 400 shown in FIG. 4). It should be understood that this particular scenario, including the example application, components of the user interfaces (e.g., releases (410, 510, 610), application environments (415, 515, 615), permissions (420, 520, 620), etc.), components of the pipeline (e.g., releases (430), deployment stages (440), etc.), and other content shown in FIGS. 4-6, are for illustrative purposes only, and are not in any way intended to limit the scope of the present disclosure.

Once a pipeline has been setup for the application (e.g., by user 205 for application 230 via pipeline manager 240 in the example system 200 shown in FIG. 2), the defined pipeline may be utilized. For example, a user may trigger execution of the pipeline by any of a variety of pre-defined mechanisms (e.g., submitting source code, clicking a button, waiting until a specified date and/or time, etc.). Once a pipeline is executed, the pipeline performs all of the operations configured (e.g., by the user 205) for building, testing, and deploying the application.

In accordance with one or more embodiments described herein, the diagnosis and optimization system 200 of the present disclosure may capture (e.g., obtain, retrieve, receive, etc.) data associated with the execution of the pipeline defined for a given application (e.g., data associated with the execution of one or more stages of the pipeline, where a “stage” may consist of core tasks (e.g., build, deploy, test) and gates on a target which can be one or more projects (e.g., multiple development or test projects)). The data associated with the execution of the pipeline, which may be captured or otherwise obtained by the system 200, may sometimes be referred to herein as “release workflow data.” Release workflow data (270) associated with an application may include, for example, data associated with building the application, data associated with deploying the application, data associated with releasing the application, and the like. In accordance with at least one embodiment, when the pipeline performs its operations the system 200 may store the captured release workflow data (e.g., in one or more databases included with or associated with the system 200).

The diagnosis and optimization system 200 may also be configured to capture production workload data (275) associated with the application. For example, in accordance with one or more embodiments described herein, after a user's application (230) has been deployed, the diagnosis and optimization system 200 may obtain “production workload data,” which may include, for example, runtime data, diagnostic data, monitoring data, and the like.

In another example, the diagnosis and optimization system 200 may determine that a user's application has been deployed, monitor the deployed application, and, based on this monitoring, generate various production workload data (275). In accordance with at least one embodiment, when the system monitors the deployed application it may determine, for example, an amount of resources being utilized by the application, how and where the resources are being used by the application (e.g., the allocation of the utilized resources across the application), etc. As with the release workflow data (270) described above, the captured production workload data (275) may also be stored by the system (e.g., in one or more databases).

With the release workflow data (270) and the production workload data (275), the system 200 (e.g., via diagnosis and optimization engine 250) may analyze the user's application and generate various suggestions/recommendations on how the user can optimize the application. In accordance with at least one embodiment, the system 200 may combine the release workflow data (270) and the production workload data (275) with pricing data (280) obtained for the application 230. Such pricing data (280) may be associated with the application 230 or may be associated with one or more other applications. For example, the system 200 may be configured to obtain pricing data from other data sources, such as data about how much it costs to run applications in various data centers across the world.

Once the system 200 analyzes the data (e.g., the release workflow data (270), the production workload data (275), the pricing data (280), and/or any combination thereof), the system 200 may generate one or more diagnosis and optimization recommendations (290). For example, the system 200 may determine that the user 205 is deploying their application to a more costly data center, and the user 205 could save money by using a different region. As another example, the system 200 may determine that the user's application 230 is receiving more traffic in a particular data center (as compared to other data centers), and therefore the user 205 can reduce CPU-load by putting up more replicas/instances in that data center. In accordance with one or more embodiments, diagnosis and optimization recommendations (290) may be generated and provided with respect to usage (e.g., whether certain existing resources can be reused or retired), performance (e.g., whether resources can be sized (up/down) in a better manner), cost (e.g., whether reservation pricing should be utilized), and numerous other factors related to an understanding of users' production workloads and release workflows, as well as cloud pricing options and availability.

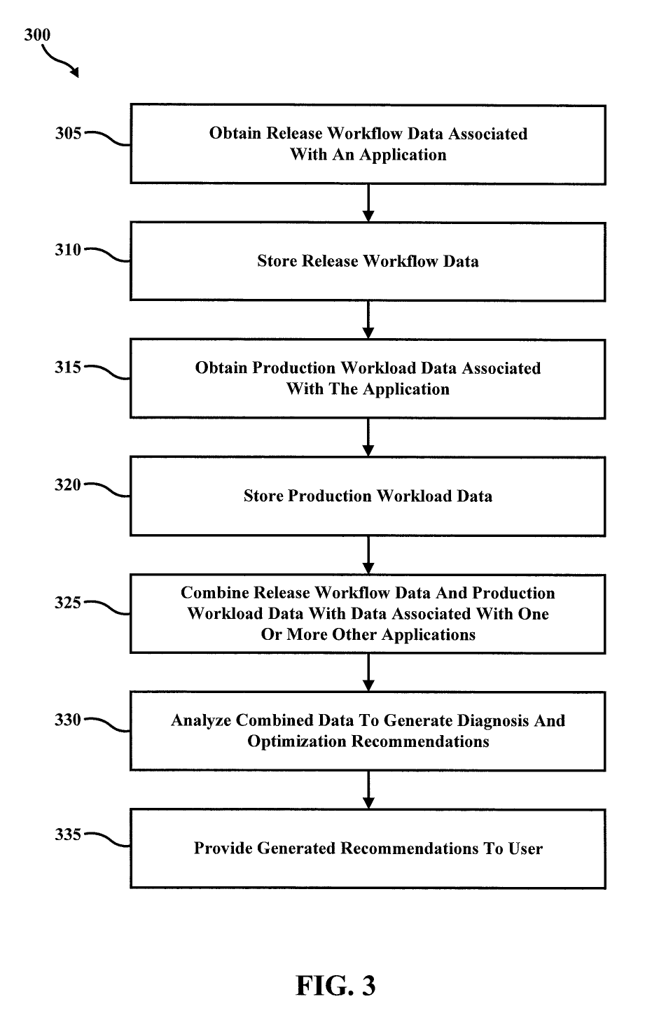

FIG. 3 illustrates an example process for providing users with recommendations on how to optimize the development and performance of their applications. In accordance with at least one embodiment, the example process 300 may be performed by a diagnosis and optimization engine (e.g., diagnosis and optimization engine 250 in the example system 200 shown in FIG. 2).

At block 305, release workflow data associated with an application may be obtained. For example, in accordance with at least one embodiment, a diagnosis and optimization engine may obtain release workflow data from a pipeline manager associated with the application (e.g., release workflow data (270) associated with application 230 and obtained from pipeline manager 240 by diagnosis and optimization engine 250 in the example system 200 shown in FIG. 2). At block 310, the release workflow data obtained at block 305 may be stored (e.g., in one or more databases included in or connected to the example system 200 shown in FIG. 2).

At block 315, production workload data associated with the application may be obtained. For example, in accordance with at least one embodiment, production workflow data may be captured by a diagnosis and optimization engine designed to determine that a user's application has been deployed, monitor the deployed application, and, based on this monitoring, generate various production workload data (e.g., production workload data (275) associated with application 230 and obtained from pipeline manager 240 by diagnosis and optimization engine 250 in the example system 200 shown in FIG. 2). In accordance with at least one embodiment, the production workload data that may be obtained at block 315 may include, for example, an amount of resources being utilized by the application, how and where the resources are being used by the application (e.g., the allocation of the utilized resources across the application), and the like. At block 320, the production workload data obtained at block 315 may be stored (e.g., in one or more databases included in or connected to the example system 200 shown in FIG. 2).

At block 325, the release workflow data obtained at block 305 for the application, and the production workload data obtained at block 315 for the application, may be combined with data associated with one or more other applications. For example, in accordance with at least one embodiment, at block 325, the release workflow data and the production workload data may be combined with pricing data (e.g., pricing data (280) in the example system 200 shown in FIG. 2) obtained for the application. Such pricing data may, for example, be associated with the application or may be associated with one or more other applications. For example, at block 325, pricing data may be obtained from one or more data sources separate from the application (e.g., external to the example system 200 shown in FIG. 2).

At block 330, the combined data (e.g., the release workflow data obtained at block 305 for the application, the production workload data obtained at block 315 for the application, and the data associated with one or more other applications (e.g., pricing data) obtained at block 325) may be analyzed to generate one or more diagnosis and optimization recommendations (e.g., diagnosis and optimization recommendations (290) in the example system 200 shown in FIG. 2).

At block 335, the diagnosis and optimization recommendations generated at block 330 may be provided to the user. For example, in accordance with at least one embodiment, the diagnosis and optimization recommendations generated at block 330 may be provided for display in a user interface screen accessible by the user (e.g., one or more of the example user interfaces 400, 500, and 600 shown in FIGS. 4, 5, and 6, respectively).

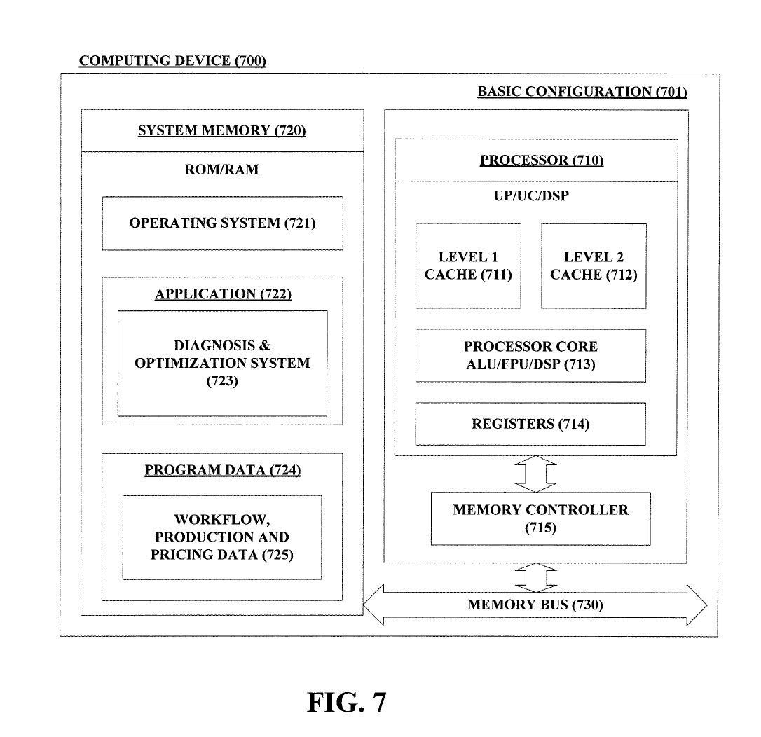

FIG. 7 is a high-level block diagram of an exemplary computer (700) that is arranged for providing users with a tool for receiving recommendations on how to optimize the development and performance of their applications. For example, in accordance with one or more embodiments described herein, the computer (700) may be configured to provide users with the ability to receive diagnostic and optimization suggestions based on data collected during various stages of the deployment pipeline for their applications. In a very basic configuration (701), the computing device (700) typically includes one or more processors (710) and system memory (720). A memory bus (730) can be used for communicating between the processor (710) and the system memory (720).

Depending on the desired configuration, the processor (710) can be of any type including but not limited to a microprocessor (μP), a microcontroller (μC), a digital signal processor (DSP), or any combination thereof. The processor (710) can include one more levels of caching, such as a level one cache (711) and a level two cache (712), a processor core (713), and registers (714). The processor core (713) can include an arithmetic logic unit (ALU), a floating point unit (FPU), a digital signal processing core (DSP Core), or any combination thereof. A memory controller (716) can also be used with the processor (710), or in some implementations the memory controller (715) can be an internal part of the processor (710).

Depending on the desired configuration, the system memory (720) can be of any type including but not limited to volatile memory (such as RAM), non-volatile memory (such as ROM, flash memory, etc.) or any combination thereof. System memory (720) typically includes an operating system (721), one or more applications (722), and program data (724). The application (722) may include a diagnosis and optimization system (e.g., system 200 as shown in FIG. 2) for capturing various data associated with, for example, building, deploying, releasing, and running an application, and utilizing such data to generate recommendations/suggestions as to how a user can balance high release productivity, ease of management, and cost optimization considerations.

Program Data (724) may include storing instructions that, when executed by the one or more processing devices, implement a system and method for providing diagnostic and optimization recommendations to a user based on data associated with the development and performance of the user's application. Additionally, in accordance with at least one embodiment, program data (724) may include workflow, production, and pricing data (725), which may relate to release workflow data and production workload data obtained for a given application, as well as various price data associated with different cloud computing offers and availability. In some embodiments, the application (722) can be arranged to operate with program data (724) on an operating system (721).

The computing device (700) can have additional features or functionality, and additional interfaces to facilitate communications between the basic configuration (701) and any required devices and interfaces.

System memory (720) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of the device (700).

The computing device (700) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (700) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location).

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
obtaining release workflow data associated with an application;
obtaining production workload data associated with the application;
storing the release workflow data and the production workload data in a database;
combining the release workflow data and the production workload data obtained for the application with data associated with one or more other applications;
analyzing the combined data to generate diagnosis and optimization recommendations; and
providing the generated recommendations to the user.

2. The method of claim 1, wherein the data associated with one or more other applications includes pricing data associated with one or more other applications.

3. The method of claim 1, wherein obtaining release workflow data associated with the application includes:
capturing data associated with the execution of one or more stages of a pipeline defined for the application.

4. The method of claim 1, wherein the release workflow data associated with the application includes at least one of data associated with building the application, data associated with deploying the application, and data associated with releasing the application.

5. The method of claim 1, wherein obtaining production workload data associated with the application includes:
determining that the application has been deployed;
monitoring the deployed application; and
generating data based on the monitoring of the deployed application.

6. The method of claim 5, wherein monitoring the deployed application includes determining an amount of resources being utilized by the deployed application.

7. The method of claim 5, wherein monitoring the deployed application includes determining an allocation of utilized resources across the deployed application.

8. The method of claim 2, wherein the pricing data associated with the one or more other applications is obtained from one or more sources separate from the application.

9. The method of claim 1, wherein providing the generated recommendations to the user includes providing the recommendations for display in a user interface screen accessible by the user.

10. A system comprising:
one or more processors; and
a non-transitory computer-readable medium coupled to said one or more processors having instructions stored thereon that, when executed by said one or more processors, cause said one or more processors to perform operations comprising:
obtaining release workflow data associated with an application;
obtaining production workload data associated with the application;
storing the release workflow data and the production workload data in a database;
combining the release workflow data and the production workload data obtained for the application with data associated with one or more other applications;
analyzing the combined data to generate diagnosis and optimization recommendations; and
providing the generated recommendations to the user.

11. The system of claim 10, wherein the data associated with one or more other applications includes pricing data associated with one or more other applications.

12. The system of claim 10, wherein the one or more processors are caused to perform further operations comprising:
capturing data associated with the execution of one or more stages of a pipeline defined for the application.

13. The system of claim 10, wherein the release workflow data associated with the application includes at least one of data associated with building the application, data associated with deploying the application, and data associated with releasing the application.

14. The system of claim 10, wherein the one or more processors are caused to perform further operations comprising:
determining that the application has been deployed;
monitoring the deployed application; and
generating data based on the monitoring of the deployed application.

15. The system of claim 14, wherein the one or more processors are caused to perform further operations comprising:
determining an amount of resources being utilized by the deployed application.

16. The system of claim 11, wherein the one or more processors are caused to perform further operations comprising:
obtaining pricing data associated with the one or more other applications from one or more sources separate from the application.

17. The system of claim 10, wherein the one or more processors are caused to perform further operations comprising:
generating a user interface screen accessible by the user; and
providing the recommendations for display in the user interface screen.

18. One or more non-transitory computer readable media storing computer-executable instructions that, when executed by one or more processors, causes the one or more processors to perform operations comprising:
obtaining release workflow data associated with an application;
obtaining production workload data associated with the application;
storing the release workflow data and the production workload data in a database;
combining the release workflow data and the production workload data obtained for the application with data associated with one or more other applications;
analyzing the combined data to generate diagnosis and optimization recommendations; and
providing the generated recommendations to the user.

19. The one or more non-transitory computer readable media of claim 18, wherein the computer-executable instructions, when executed by the one or more processors, causes the one or more processors to perform further operations comprising:
capturing data associated with the execution of one or more stages of a pipeline defined for the application.

20. The one or more non-transitory computer readable media of claim 18, wherein the computer-executable instructions, when executed by the one or more processors, causes the one or more processors to perform further operations comprising:
determining that the application has been deployed;
monitoring the deployed application; and
generating data based on the monitoring of the deployed application.

21. The one or more non-transitory computer readable media of claim 18, wherein the data associated with one or more other applications includes pricing data associated with one or more other applications.

22. The one or more non-transitory computer readable media of claim 18, wherein the release workflow data associated with the application includes at least one of data associated with building the application, data associated with deploying the application, and data associated with releasing the application.
